(19) United States
(12) Patent Application Publication
(10) Pub. No.: US 2016/0014263 A1
(43) Pub. Date: Jan. 14, 2016

(54) Apparatus, System, and Method for Preventing Distracted Driving

(71) Applicants: Bryce Carrico, Fort Wayne, IN (US); Kurt Cantwell, Auburn, IN (US); Erik Cowans, Fort Wayne, IN (US)

(72) Inventors: Bryce Carrico, Fort Wayne, IN (US); Kurt Cantwell, Auburn, IN (US); Erik Cowans, Fort Wayne, IN (US)

(21) Appl. No.: 14/330,761

(22) Filed: Jul. 14, 2014

(51) Int. Cl. H04M 1/725; B60R 16/023

(52) U.S. Cl. CPC H04M 1/72577; H04M 1/72575; B60R 16/023

(57) ABSTRACT

A system for controlling access to a handheld device by a vehicle operator while the vehicle is in operation; the system comprises: a handheld device; and an apparatus for mechanically controlling access by a vehicle operator to the handheld device while the vehicle is being operated by the vehicle operator, the apparatus comprising: a housing, said housing comprising a releasable lid, said lid hingedly connected to said housing; means for selectively locking said lid in a closed position relative to said housing; a means for operably connecting said apparatus to a vehicle ignition system; means for electronically connecting said handheld device to the interior of said housing; means for electronically connecting said apparatus to a power source; and means for electronically monitoring and recording certain preselected data related to the use and function of said apparatus.

### BACKGROUND

1. Field of the Art

The present invention relates generally to a means for preventing distracted driving. More specifically, the present invention relates to a mechanical apparatus, system, and method for preventing a mobile phone from distracting vehicle operators.

2. Description of the Prior Art

U.S. Pat. No. 5,836,563 discloses a mobile phone holder is disclosed which can be opened or closed by a single push of one hand. The mobile phone thus may be fetched readily or be placed therein handily without distracting too much of a driver's attention and is much safer to use. It includes mainly a frame, a cover, a clamp, an elastic member, a gear, a push button, a toggle member and a spring. When the toggle member is pushed, the clamp will hold the phone securely in the frame. The toggle member is pivotally moveable in the opening of the frame. The spring is provided for moving the toggle slantly outside the opening of the frame when external force is absent. When the push button is pressed, the clamp will be moved outwardly to free the phone for fetching and use. All of this may be done singlehanded easily. It thus greatly enhances the driving safety when using in a car.

U.S. Pat. No. 6,311,078 discloses a wireless telephone which does not generate an alerting-signal if the speed at which the wireless telephone is moving exceeds a predefined speed when an incoming call is received. If an alerting signal is not generated for an incoming call, the wireless telephone transmits a message back to the calling party informing them that they have contacted the wireless telephone and may leave either a voice or data message. The caller can then either leave a voice message or touch tone in the caller's telephone number. Further, the wireless telephone can inhibit the origination of calls from the wireless telephone if the speed of the wireless telephone exceeds the predefined speed. In addition, if the speed has not been equal or less than the predefined speed for a predefined amount of time, call originations and alerting signals are blocked.

U.S. Pat. No. 6,728,542 discloses a wireless communications system which includes at least one base station for communicating with a mobile unit. A mobile switching center is responsive to the base station and operative for switching calls with a calling party and a mobile unit via the base station. One of at least a mobile switching center or base station includes a processor that is operative for determining the speed of the mobile unit. In response to a call from a calling party to the mobile unit, when the calculated speed is above a threshold, the call is switched to a voice message indicating that a mobile unit operator is traveling and not receiving any calls.

U.S. Pat. No. 6,600,975 discloses an in-vehicle communication device that automatically answers a caller device that sends a call when a telephone device located in a vehicle receives the call comprising: in-vehicle sensors that detect vehicle conditions, a communication interface for the telephone device, and a control device that controls the telephone device via the communication interface, wherein the control device acquires the vehicle conditions which are detected by the in-vehicle sensors, judges whether a driver's answering the call is dangerous or not based on the acquired vehicle conditions when the control device detects the call to the telephone device, prepares an answer message including vehicle information that depends upon a running condition of the vehicle at the time when the driver's answering the call is judged to be dangerous, and sends the prepared answer message to the caller device.

U.S. Pat. No. 6,922,571 discloses a mobile phone network that confirms the moving state of the mobile terminal. If the mobile terminal is found to be moving, the mobile phone network notifies the mobile terminal of the fact that a call was received by the mobile terminal and also notifies the caller's telephone terminal of the fact that the called party's mobile terminal is moving, and causes the caller's terminal to call again after the lapse of a predetermined time. If the called party's terminal is found to be not moving, the mobile phone network transmits a calling signal to the mobile terminal.

U.S. Pat. No. 7,684,991 discloses a digital audio file search method and an apparatus for digital audio files is provided that allows a user to navigate the audio files by generating speech sounds related to the information of the audio files to facilitate searching and playback. The digital audio file search method and apparatus searches for audio files in a portable digital audio player in combination with an automobile audio system through speech sounds by utilizing text-to-speech processing and by prompting response from a user in response to the generated speech sounds. The text-to-speech technology is utilized to generate the speech sound based on tag-data of the audio files. When hearing the speech sounds, the user gives instruction for searching the files without being distracted from driving the automobile.

U.S. Pat. No. 8,045,976 discloses a mobility call management service that provides enhanced call management functionality for a wireless mobile terminal (MT). Incoming and/or outgoing calls are managed based on an assessment of the degree of motion of the MT, or other available data pertinent to the MT's physical situation, such as but not limited to it's location, movement, or rate of movement. The degree of motion or other assessment may be used to determine whether a communication can safely terminate on, originate from, or continue safely on the MT, so as to reduce or remove driver distraction.

U.S. Pat. No. 8,103,402 discloses an apparatus, method, and system to enforce compliance with Transportation Safety Policies (TSP) governing vehicle fleets, subways, trains, busses, airplanes, etc. The apparatus identifies, authenticates, authorizes and logs-in all drivers/operators before enabling vehicle operation. Assigned privileges are granted to Transportation Safety System (TSS) enrolled drivers/operators. After drivers/operators log-in, the apparatus detects, reports, and alarms safety violations to the governing TSS. Biometric log-in precludes driver/operator repudiation. In preferred embodiments, biometric readers and/or card-based fingerprint readers are mounted into vehicle dashboards for driver/operator authentication/log-in. The invention helps reduce inattentiveness accidents due to unauthorized wireless use (phoning, texting, Internet, games, etc.). Unauthorized wireless usage by drivers/operators is detected in driving and control areas. All unauthorized activity is logged, alarmed and/or reported to Transportation Safety System administrators, depending on incident type, severity, and/or safety violation. Remediation action varies from issuing warnings, to logging violations, to incapacitating vehicles forcing safety stops requiring supervisory intervention.

U.S. Pat. No. 8,145,199 discloses controlling mobile device functions and features, along with systems incorporating these devices and methods. For example, it limits or disables the use of some of mobile device features which could cause distraction to the user, when the user is engaged in another activity. In an example, it enables other mobile device features based on occurrence of events related to the user or environment. Another example addresses controlling the mobile device features, such as SMS, while the user is in a vehicle or driving. Another example restricts the ability of the driver of a vehicle to text, while the vehicle is in motion, by automatically disabling the texting ability of mobile device within and around the perimeter of the driver's seat. Other variations, examples, improvements, detection mechanisms, models, techniques, calculations, verification mechanisms, and features are also described in details.

U.S. Pat. No. 8,212,661 discloses an electronic communication system which provides text or voice messages to remote receiving devices, such as cell phones or PDA's. The remote receiving devices are equipped with velocity sensors, or position sensors from which velocity may be inferred. The remote receiving devices periodically report a velocity or current position to an alert signal control node of the communication system. The alert signal control node determines a most recent-determinable velocity for each receiving device before transmitting a message alert signal. If the velocity exceeds a predetermined threshold, the alert signal may be delayed until the velocity drops below the threshold. The system may be operated as a safety measure to prevent reception of distracting alert signals while driving, thereby silencing messaging devices at appropriate times.

U.S. Pat. No. 8,315,617 discloses controlling mobile device functions and features. For example, it limits or disables the use of some of mobile device features which could cause distraction to the user, when the user is engaged in another activity. In an example, it enables other mobile device features based on occurrence of events related to the user or environment. Another example addresses controlling the mobile device features, such as SMS, while the user is in a vehicle or driving. Another example restricts the ability of the driver of a vehicle to text, while the vehicle is in motion, by automatically disabling the texting ability of mobile device within and around the perimeter of the driver's seat. Other variations, examples, improvements, detection mechanisms, models, techniques, calculations, verification mechanisms, and features are also described in details.

U.S. Pat. No. 8,401,578 discloses a selective cell phone text messaging function disabling system which prevents a vehicle occupant from text messaging while driving. Other occupants of the vehicle can text message using their cell phones. The driver's cell phone text messaging functionality is turned off by a signal broadcasting system as the driver enters the vehicle through the driver-side door. When the driver exits the vehicle through the driver-side door, the cell phone resumes its texting capability, preserving text messaging functionality while the driver is not operating the vehicle.

U.S. Pat. No. 8,442,490 discloses a system for restricting uses of moving phones used by drivers, but not passenger phones, and sometimes interrupting voice calls, including: (a) Provide for more than one level or state of restriction. (b) When a caller calls a person driving, play to the caller a query whether the call is important enough to put through, and put it through only if the caller responds affirmatively. (c) The phone is restricted in functionality when the vehicle is determined to be experiencing acceleration greater than a threshold. The restricting may be to play an alert sound to be heard by people listening to a voice conversation on the phone. The restricting may be to suspend a voice conversation on the phone.

U.S. Pat. No. 8,446,270 discloses an electronic communication system which provides text or voice messages to remote receiving devices, such as cell phones or PDA's. The remote receiving devices are equipped with velocity sensors, or position sensors from which velocity may be inferred. The remote receiving devices periodically report a velocity or current position to an alert signal control node of the communication system. The alert signal control node determines a most recent-determinable velocity for each receiving device before transmitting a message alert signal. If the velocity exceeds a predetermined threshold, the alert signal may be delayed until the velocity drops below the threshold. The system may be operated as a safety measure to prevent reception of distracting alert signals while driving, thereby silencing messaging devices at appropriate times.

U.S. Pat. No. 8,526,973 discloses a safety system that prevents the use of certain Smartphone functions and replace the blocked functions with alternative ways to communicate while in a car. These functions include text, voice (manually dialing to make calls) and internet. Smartphone includes any mobile phone or portable communication device that allows software applications to be downloaded and run on its operating system. The system uses a local RF transmitter located and mounted in the car to send a signal that can be detected by one or all of the Smartphone's in the car. The Smartphone's, which have downloaded the application, will decode the RF signal and disable and/or activate certain functions of the Smartphone. Which functions to disable and/or activate are previously chosen by a user of the downloaded application. By use of this system, young drivers, but not limited to, will not be distracted while driving, and thus forced to pay attention to their surroundings. Therefore automobile accidents will be reduced.

U.S. Pat. No. 8,527,013 discloses systems, methods, and devices for controlling and limiting use of functions, such as calling, texting, chatting, emailing, Internet surfing, and similar applications, on a mobile device when the mobile device is in a moving vehicle, includes use of an on-board computer installed within the vehicle, a transmitter in electronic communication with the on-board computer that periodically transmits speed data of the vehicle to a receiver installed on the mobile device, wherein the mobile device includes suitable software and a rules-based policy that define and control when and which functions of the mobile device are disabled or interrupted by the software when the vehicle is in motion above a minimum threshold speed. Policies are set by default but may be customized for particular individuals, devices, or circumstances. Policies may also be customized for particular groups or subgroups of employees or contractors for company or legal compliance to reduce distracted driving.

### SUMMARY

In one exemplary embodiment, the present invention provides an apparatus for mechanically controlling access by a vehicle operator to a handheld device while the vehicle is being operated by the vehicle operator, the apparatus comprising: a housing, said housing comprising a releasable lid, said lid hingedly connected to said housing; means for selectively locking said lid in a closed position relative to said housing; a means for operably connecting said apparatus to a vehicle ignition system; means for electronically connecting said handheld device to the interior of said housing; means for electronically connecting said apparatus to a power source; means for electronically monitoring and recording certain preselected data related to the use and function of said apparatus.

In another exemplary embodiment, the present invention provides a system for controlling access to a handheld device by a vehicle operator while the vehicle is in operation; the system comprises: a handheld device; and an apparatus for mechanically controlling access by a vehicle operator to the handheld device while the vehicle is being operated by the vehicle operator, the apparatus comprising: a housing, said housing comprising a releasable lid, said lid hingedly connected to said housing; means for selectively locking said lid in a closed position relative to said housing; a means for operably connecting said apparatus to a vehicle ignition system; means for electronically connecting said handheld device to the interior of said housing; means for electronically connecting said apparatus to a power source; and means for electronically monitoring and recording certain preselected data related to the use and function of said apparatus.

In yet another exemplary embodiment, the present invention provides a method of mechanically controlling access by a vehicle operator to a handheld device, the method comprising the steps of: providing a docking device that mechanically limits access to a handheld device; logging, certain predetermined uses of said handheld device; and limiting operation of a vehicle based on presence or absence of said handheld device.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a front view of a distracted driving prevention apparatus according to the present invention.

FIG. 2 shows a front perspective view of a distracted driving prevention apparatus according to the present invention.

FIG. 3 shows a side view of a distracted driving prevention apparatus according to the present invention.

FIG. 4 shows a top view of a distracted driving prevention apparatus according to the present invention.

FIG. 5 shows a side cross-sectional view of a distracted driving prevention apparatus in accordance with the present invention.

FIG. 6 shows a front view of a distracted driving prevention apparatus in accordance with the present invention with the cover open and closed.

FIG. 7 shows a schematic diagram of a distracted driving prevention apparatus in accordance with the present invention connected to a vehicle ignition system and a vehicle power source.

FIG. 8 shows a flow chart of the operation of a distracted driving prevention apparatus in accordance with the present invention.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

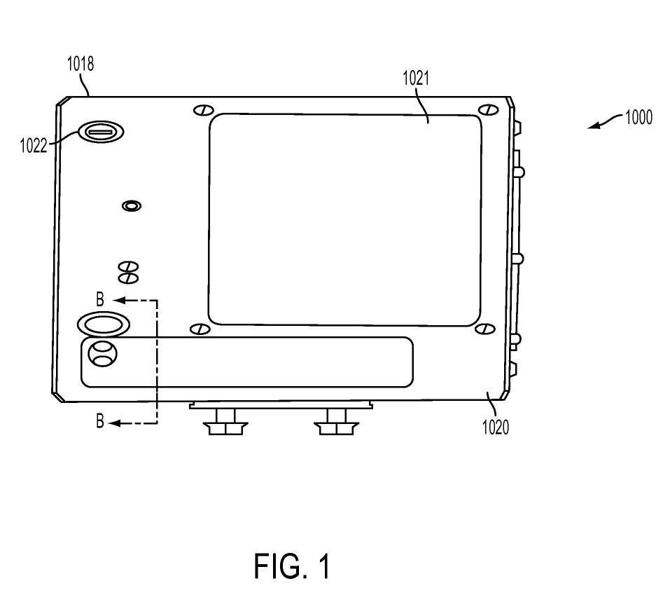

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The following definitions shall apply herein:
Download—means to receive data to a local system from a remote system, or to initiate such a data transfer. Examples of a remote system from which a download might be performed include a Webserver, FTP server, email server, or other similar systems. A download means the process of receiving such a file.
Firmware—is a fixed, usually rather small, program and/or data structure that internally controls various electronic devices and microcontrollers.
Global Positioning System (“GPS”)—is a space-based global navigation satellite system that provides reliable location and time information in all weather and at all times and anywhere on or near the Earth when and where there is an unobstructed line of sight to four or more GPS satellites. It is maintained by the United States government and is freely accessible by, anyone with a GPS receiver.
Software—is the collection of computer programs and related data that provide the instructions telling a computer what to do. Software refers to one or more computer programs and data held in the storage of the computer for some purpose. Program software performs the function of the program it implements, either by directly providing instructions to the computer hardware or by serving as input to another piece of software.
Thumb Drive or USB Flash Drive—is a flash memory data storage device integrated with a Universal Serial Bus interface. USB flash drives are typically removable and rewritable, and physically much smaller than a floppy disk.
Twisted Pair Cabling—is a type of wiring in which two conductors (the forward and return conductors of a single circuit) are twisted together for the purposes of canceling out electromagnetic interference (“EM”) from external sources.
Update—is an enhancement or repair of the device or supporting software.
Upload—is the sending of data from a local device to a remote device with the intent that the remote system should store a copy of the new data being transferred.
Universal Serial Bus (“USB”)—is a specification to establish communication between devices and a host controller (usually personal computers). USB can connect computer peripherals such as mice, keyboards, digital cameras, printers, personal media players, flash drives, Network Adapters, and external hard drives in addition to providing power to a device.

Referring first to FIG. 1, there is shown a front view of a distracted driving prevention apparatus 1000 according to the present invention. Distracted driver prevention apparatus 1000 generally comprises an enclosure for securing an operator's handheld device while operating a vehicle.

In an exemplary embodiment, apparatus 1000 comprises a rigid box structure 1010 having a removable lid 1020. Apparatus 1000 is preferably constructed of durable, light weight materials to allow for consistent and inexpensive mass construction, such as aluminum, steel, alloy, thermoplastic, thermoset, or composite material. In preferred embodiment, apparatus 1000 comprises materials that are corrosion resistant to allow apparatus 1000 to be cleaned by water.

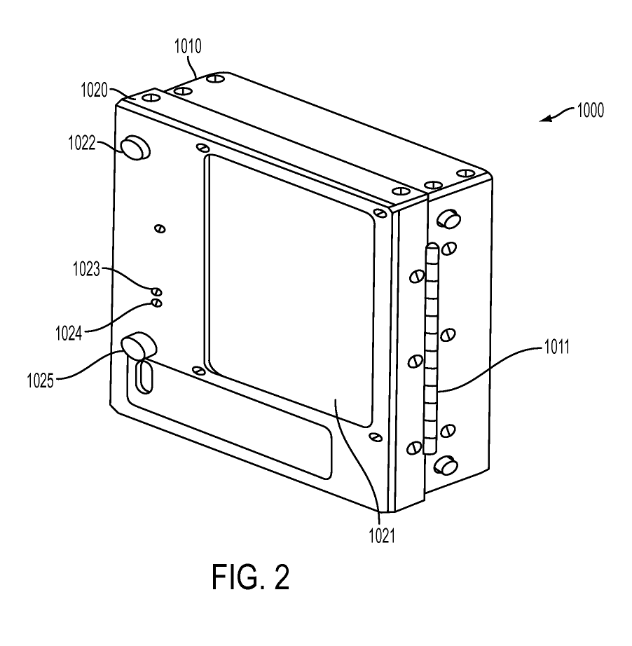

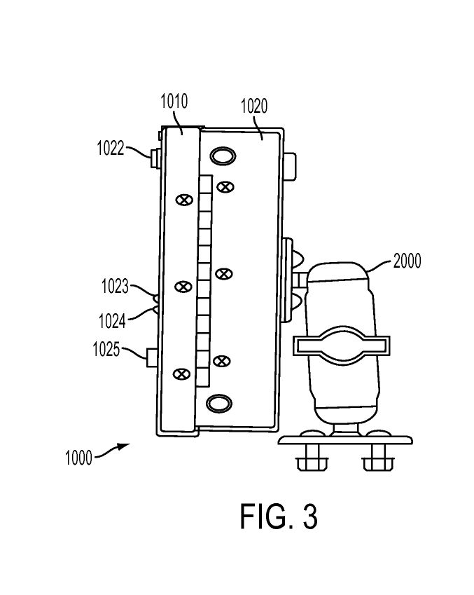

Referring additionally now to FIG. 2, there is shown a front perspective view of distracted driving prevention apparatus 1000. As shown in FIGS. 1 and 2; apparatus 1000 comprises base 1010 and lid 1020. Lid 1020 is preferably hingedly connected to base 1010 of apparatus 1000. Although, hinge 1011 is shown on the right side of apparatus 1000 (see FIG. 3), those of skill in the art will appreciate that hinge 1000 could be on the left, top, or bottom of apparatus 1000.

Referring still to FIG. 1, lid 1020 of apparatus 1000 further preferably comprises cam lock 1022. Cam lock 1022 is disposed between lid 1020 and base 1010 such that lid 1020 can be secured in a closed position relative to base 1010. Those of skill in the art will appreciate that other locking means might be used. For example, lock 1022 may be actuated without a key. Alternatively, a mechanical or electrical combination lock, biometric lock, voice activated lock or other securing means may be employed within the scope of the present invention. Lid 1020 of apparatus 1000 further comprises a transparent window 1021. Window 1021 may be comprised of polycarbonate, polystyrene, tempered glass, or any other sturdy, transparent material.

In a preferred embodiment, distracted driving apparatus 1000 is preferably semi-permanently affixed to the interior of a moving vehicle, preferably on a dashboard within the line of sight of the vehicle's operator.

Referring now to FIG. 3, there is shown a right side view of apparatus 1000 according to an embodiment of the present invention. As shown in FIG. 3, base 1010 of distracted driving prevention apparatus 1000 is preferably attached to an adjustable mount 2000. Adjustable mount 2000 is preferably rigidly attached to the interior of a vehicle such as a truck, van, or car dashboard.

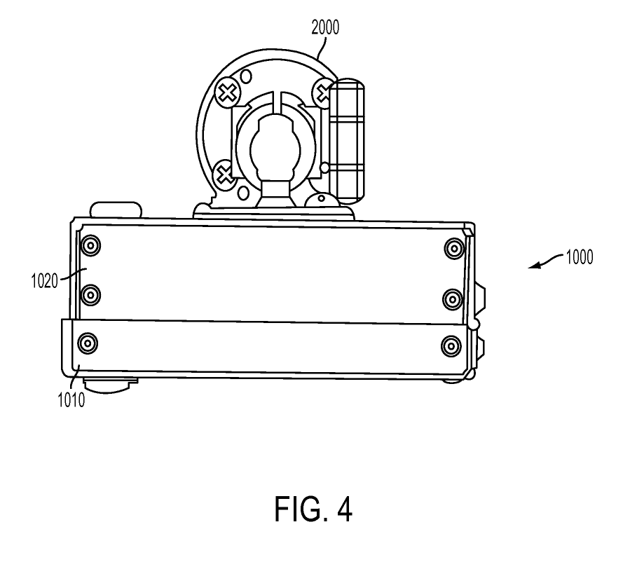

As shown in FIG. 3 and FIG. 4 (a top view of distracted driving prevention apparatus 1000), adjustable mount 2000 is preferably designed such that it allows distracted driving prevention apparatus 1000 to be movable vertically, horizontally, rotationally, and telescopically relative to a vehicle dashboard.

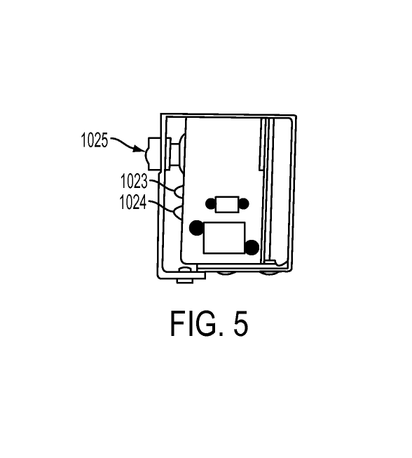

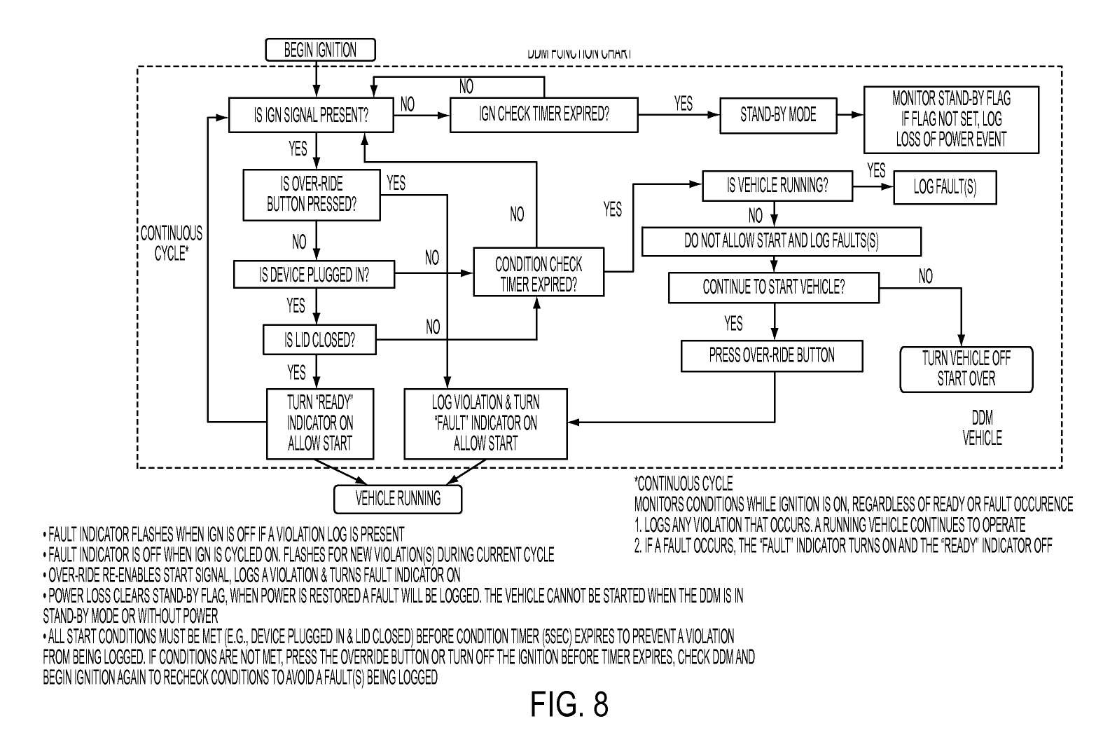

Referring now to FIG. 5, there is shown a side cross-sectional view of distracted driving apparatus 1000 according to the present invention. In the exemplary embodiment illustrated in FIG. 5, there is shown manual override button 1025. When engaged, override button 1025 allows a connected vehicle to function when apparatus 1000 would otherwise prevent the same as described in more detail below in reference to FIG. 8 herein.

Referring still to FIG. 5, there are further illustrated visual indicator lights 1023 and 1024. Light 1023 preferably indicates a positive operating condition, and light 1024 preferably indicates a “fault” condition, as will be described in further detail below.

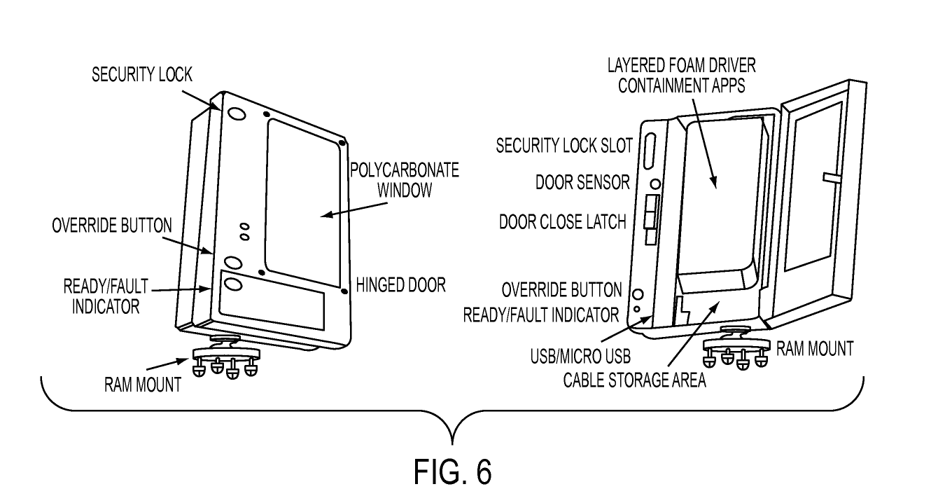

Turning now to FIG. 6, there is shown a front perspective view of distracted driving prevention apparatus 1000 where lid 1020 is in the open position relative to base 1010. As illustrated in FIG. 6, the interior of distracted driving apparatus 1000 is adapted to receive a handheld device such as a cell phone, satellite phone, or tablet computer, preferably one having wireless Internet or other wireless communication capability.

As further illustrated in FIG. 6, the interior of distracted driving prevention apparatus 1000 preferably comprises a padded interior 3000 to receive and hold the handheld device. In a preferred embodiment, padded interior 3000 is customized to snugly fit around the interior of specific brands of handheld devices. Distracted driving prevention apparatus 1000 further comprises a door close sensor 1030. The padding is designed with multiple layers which can be adjusted to create a good fit for each type of device. The device should have enough foam behind it to be held firmly against the window 1021 when the door is closed. This keeps the device safe and secure when driving. The charging cord must be connected to the phone and routed down to the USB connector at the bottom left of the padded area. If the device does not charge via USB, an adapter will be needed. The cord can be coiled up and stored in the space adjacent to the padded area. FIG. 5 shows possible USB connectors, 1025 and 1026, within apparatus 1000.

Referring still to FIG. 6, the interior of distracted driving prevention apparatus 1000 further comprises a USB port to which a handheld device may be electronically connected, thus allowing data sharing between the handheld device and apparatus 1000 as well as power transfer to the handheld device.

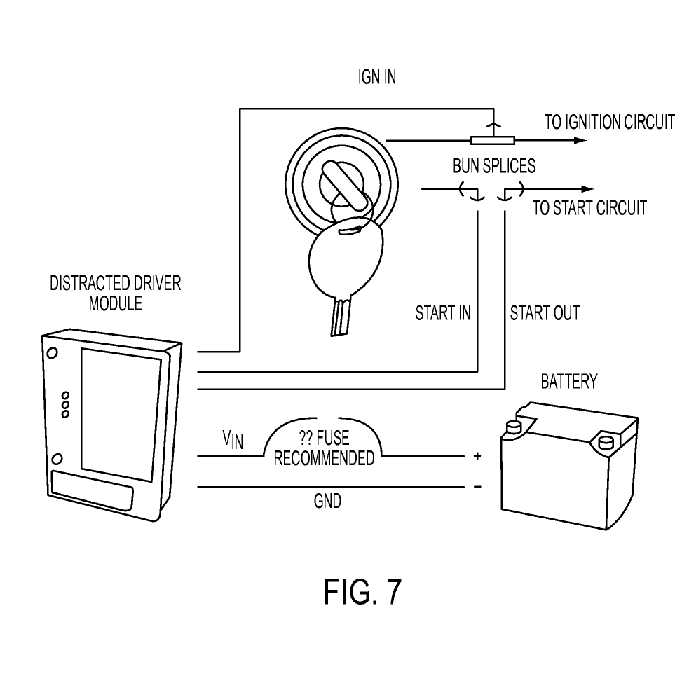

Referring now to FIG. 7, there is shown a schematic diagram of distracted driving prevention apparatus 1000 operably connected to a power source, preferably the battery of a vehicle. In use, a handheld device is maintained within the interior (FIG. 6) of distracted driving prevention apparatus 1000. The handheld device is electronically connected to apparatus 1000 which is itself electronically connected to a vehicle power source as illustrated in FIG. 7.

In a preferred embodiment of the present invention, the handheld device must be plugged in and lid 1020 of apparatus 1000 must be closed to be able to start the vehicle. In an emergency situation, the vehicle can be started after pressing manual override button 1022; however, this will log a fault in the onboard memory (not shown) of apparatus 1000. When the handheld device is secured within distracted driving apparatus 1000, it is able to charge and the screen is visible from outside the apparatus through window 1021. Thus, the vehicle operator can use hands free accessories and be notified of incoming calls, use the device's GPS, etc. However, if direct use of the device is required, the operator is instructed to stop the vehicle in a safe location and turn off the ignition before opening distracted driving prevention apparatus 1000.

Upon installation, distracted driving prevention apparatus 1000 is spliced into the vehicle OEM wiring harness. The module is wired to power and ground as well as an ignition line and ignition start signal line. The ignition line is used to determine if the vehicle is in a run state and is used to resume distracted driving prevention apparatus 1000 from a sleep state. The start line is used to send a signal to the starter motor during ignition when conditions are met, but it is otherwise inactive.

In the preferred embodiment, wires labeled GND and Vin need to be sourced to ground and a 12V power supply respectively. The wire labeled IGN-IN is “T” spliced into the ignition signal wire. This wire is live when the vehicle is in motion. The START IN and START OUT wires are spliced in line with the START wire which signals the ECU or relay to send power to the starter motor.

In the preferred embodiment, distracted driving prevention apparatus 1000 is wired with a 5 Amp fuse to the 12V power source. The module itself should be installed somewhere on the dash or center console of the vehicle where it is not obstructing the view outside or proper operation of the vehicle. It is also recommended that it be installed so that the driver can easily access the device in an emergency.

Distracted driving prevention apparatus 1000 is preferably preprogrammed to have a unique ID number. This can be reprogrammed (for example, to be the VIN number in the vehicle it is installed), but the original module ID number is included with the module: Distracted driving prevention apparatus 1000 also has a Real Time Clock (“RTC”) from the point of manufacture.

The design of distracted driving prevention apparatus 1000 is meant to keep the driver. from being distracted by the device through interaction. However, distracted driving prevention apparatus 1000 allows a vehicle operator to see incoming calls or text messages on the device through the window 1021. This window can also allow use of the handheld device's built in GPS, if available.

As illustrated in FIG. 3, mount 2000 allows distracted driving prevention apparatus 1000 to be positioned in almost any orientation relative to the vehicle operator. Distracted driving prevention apparatus 1000 further allows the use of hands free accessories such as Bluetooth headsets. If the device needs to be physically addressed, the vehicle should be parked in a safe location and turned off. Failure to turn off the vehicle before opening the lid 1020 on the apparatus 1000 and/or unplugging the device from distracted driving prevention apparatus 1000 will result in a fault(s) logged to the software of apparatus 1000.

Referring now to FIG. 8, there is shown a flow chart of the operation of distracted driving prevention apparatus 1000 in accordance with the present invention. As illustrated in FIG. 8, distracted driving prevention apparatus 1000 comprises a control module that incorporates software such that apparatus 1000 operates as follows when installed in a vehicle:

With the vehicle off, the entire distracted driving prevention apparatus 1000 is shut down and draws almost no current. It is waiting for an ignition signal to wake up and check to see if start conditions are met. These start conditions consist of a device being plugged into USB port 1025 or 1026 inside distracted driving prevention apparatus 1000 and lid 1020 of distracted driving prevention apparatus 1000 closed.

When the vehicle is off, distracted driving prevention apparatus 1000 module is in a low power sleep state. When the ignition line becomes active (i.e. when the key is inserted and turned to the on/run/ignition position) distracted driving prevention apparatus 1000 wakes up and checks for the conditions to be met for securing a device for a 5 second period. (Those of skill in the art will appreciate that the period for checking may be programmed to any desired time.) These conditions are that a device is plugged in and the door on distracted driving prevention apparatus 1000 is closed. Once these conditions are met the module will allow the start signal from the vehicle to pass through and start the vehicle. A timer is programmed into distracted driving prevention apparatus 1000 such that when the key is first turned to the ignition position distracted driving prevention apparatus 1000 can check to determine if its desired operating conditions have been met. In the preferred embodiment, the timer will allow for five seconds, but those of skill in the art will appreciate that any desired time frame may be used.

If starting conditions are not met within the desired time frame, a fault will be logged corresponding to which condition was not met. This can be avoided by cycling the ignition off and checking for the conditions before turning the ignition back on; the 5 second timer will be reset. When the vehicle is shut down the module will return to sleep after 5 seconds.

If the start conditions are met, the distracted driving prevention apparatus 1000 will pass the start signal through to the starter circuit (either a relay, the ECU, etc.) and the vehicle will start normally. In addition, positive indicator light 1023 on the front of the panel will illuminate.

If the appropriate conditions are not met within the programmed time limit, for example if a device is plugged in but the door is open, the module will interrupt the start signal, the vehicle will be prevented from starting and a fault will be logged. Similarly, if the vehicle is in operation and the door opens or the device is unplugged, the module will log these faults as well but the vehicle will continue to operate. When distracted driving prevention apparatus 1000 logs a fault, the red fault indicator light 1025 on the front of the panel will flash.

Fault indicator light 1025 will turn off the next time the ignition is cycled ON until new faults are logged. Whenever any faults are logged, fault indicator light 1025 will flash when the vehicle is off. Table 1 lists the set of possible conditions and the resulting actions distracted driving prevention apparatus 1000 will take. When distracted driving prevention apparatus 1000 is wired correctly and conditions are met, it should not affect the proper operation of the vehicle.

| Action | Result |
|---|---|
| Vehicle key turned to IGNITION | Distracted driver prevention apparatus |
| position. | (“DDPA”) wakes up and checks for start |
| | conditions to be met within 5 seconds |
| Vehicle key turned to START position. | DDPA logs fault if conditions are not met |
| | within 5 seconds or grants start access if |
| | conditions are met. Appropriate indicator |
| | illuminates. |
| Vehicle key is OFF position. | DDPA enters sleep state. |
| Override button on the DDPA is | The override violation is logged and fault |
| pressed. | indicator flashes if the apparatus is awake. |
| Vehicle in operation and DDPA door is | DDPA logs corresponding fault and red |
| opened OR device is unplugged. | indicator flashes. |
| Vehicle in operation, DDPA door is | DDPA logs additional fault corresponding to |
| opened AND device is unplugged. | the second event and red fault indicator |
| | remains flashing. |
| DDPA loses power or ground. | Device enters sleep state and backup battery |
| | keeps RTC operational. Upon restoring |
| | power, DDPA recognizes the absent proper |
| | shutdown flag and logs corresponding fault, |
| | red indicator flashes. |
| DDPA loses IGNITION or ignition | DDPA detects line inactive and enters sleep |
| signal line. | state. |
| DDPA loses either START signal line. | Fault is not logged but vehicle will be unable |
| | to start. |
| DDPA detects unauthorized mini USB | DDPA will log a fault and flash the red |
| device. | indicator. |

Distracted driving prevention apparatus 1000 will not log a fault until connected to 12V power. It will log a fault if power is removed. When distracted driving prevention apparatus 1000 is first installed, a fault will be logged that needs to be cleared to begin new operation. When a fault is detected the time, date, and type of fault is saved into memory. Table 2 shows an exemplary set of fault numbers and corresponding types.

As previously discussed, fault indicator light 1024 of distracted driving prevention apparatus 1000 will flash to signal a fault has been detected. Indicator light 1024 will continue flashing from this point forward whenever the vehicle is shut down, until the fault or faults are cleared by a user within the software or a new ignition session is initiated. If faults still exist after a successful session, when shutdown the fault indicator will resume flashing.

| Problem | | Solution |
|---|---|---|
| 1 | DDPA Door is closed but green light | Ensure the module has power and the device |
| | remains off in ignition (check state). | is plugged into the USB port inside the |
| | | DDPA. |
| 2 | DDPA is connected to the USB port but | Ensure the module has power and the DDPA |
| | green light fails to light in ignition (check | door is closed securely. |
| | state). | |
| 3 | DDPA is connected and door is closed | Ensure the module ignition wire (ING IN), |
| | but green light remains off in ignition | power (Vin), and ground (GND) wires are |
| | (check state). | connected correctly. Also check for an |
| | | improper device inserted into the USB port. |
| 4 | Green indicator light is illuminated but | Ensure that the start wires (START IN, |
| | the engine will not start. | START OUT) are properly connected. |
| 5 | The vehicle is running and either START | Vehicle will continue to run normally until |
| | wire is disconnected. | shutdown. Then the vehicle will be unable |
| | | to be restarted. |
| 6 | The vehicle is running and the | The module will go into a sleep state and the |
| | IGNITION wire is disconnected. | vehicle will continue to operate normally. |
| | | Once shutdown, the vehicle will be unable |
| | | to be restarted. |
| 7 | The vehicle is running and the POWER | Vehicle will continue to run normally until |
| | or GROUND lines are disconnected. | shutdown. The vehicle will be unable to be |
| | | restarted. When power is restored a fault |
| | | will be logged. |

The next time the vehicle is started, distracted driving prevention apparatus 1000 will check start conditions and illuminate the green READY indicator 1023 if they are met; the red fault indicator 1024 will not continue flashing during resumed proper operation. The vehicle can be started by first inserting the key and turning it to on/run/ignition position to wake up the module and then pressing the override button 1022 on the front of distracted driving prevention apparatus 1000. This will log a fault violation but then the vehicle can be started normally.

In the event that the power or ground lines are disconnected during use, distracted driving prevention apparatus 1000 can have a backup battery and will log this to onboard memory once power is restored. All of the fault records and software will be accessible using a specific USB device. Depending on the access required, the USB device can grant access to features such as allowing the truck to be run without logging faults, update software or firmware, or download and clear faults.

Two types of preprogrammed USB flash drives will be available for use with distracted driving prevention apparatus 1000, a “Manager Mode” drive and a “Maintenance Mode” drive. Use of an unauthorized drive in the mini USB port will log a fault and not change the operation of distracted driving prevention apparatus 1000. The Maintenance drive-temporarily disables distracted driving prevention apparatus 1000 features and allows the vehicle to be moved around and serviced without logging faults.

The manager drive will download the recorded faults from distracted driving prevention apparatus 1000 memory to the drive in a tabulated format or in a desired predetermined software system. The fault list can then be moved to a computer where it can be stored and organized however the owner wishes. The Manager drive also has all the features of the Maintenance drive.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. An apparatus for mechanically controlling access by a vehicle operator to a handheld device while the vehicle is being operated by the vehicle operator, the apparatus comprising: a housing, said housing comprising a releasable lid; a means for selectively closing said lid relative to said housing; a means for operably connecting said apparatus to a vehicle ignition system; a means for electronically connecting said handheld device to said housing; and a means for electronically monitoring and recording data related to said apparatus.

2. The apparatus of claim 1, further comprising means for electronically connecting said apparatus to a power source.

3. The apparatus of claim 1, wherein the lid of the housing is at least partially transparent and wherein the transparent portion of the lid comprises a material selected from the group consisting of glass, polystyrene, polycarbonate, and silicone.

4. The apparatus of claim 1, wherein the apparatus does not comprise a means of wirelessly disrupting an electronic signal communicated to or from the handheld device.

5. The apparatus of claim 1, wherein the apparatus further comprises means for releasably, movably, and mechanically connecting said housing to the interior of said vehicle.

6. The apparatus of claim 1, wherein the housing of the apparatus is generally constructed of a material selected from the group consisting of aluminum, thermoplastic, thermoset, composite, and stainless steel.

7. The apparatus of claim 1, wherein the apparatus further comprises a manual override switch operably connected between the device and the ignition and the vehicle.

8. The apparatus of claim 1, wherein the apparatus further comprises a USB connection between the apparatus and the handheld device.

9. The apparatus of claim 1, wherein the apparatus further comprises a second power source, wherein the second power source is selected from the group consisting of a lead acid battery, a nickel cadmium battery, a lithium ion battery, and a solar cell.

10. The apparatus of claim 1, wherein the means for selectively closing said lid relative to said housing comprises a lock, said lock selected from the group consisting of a key lock, a combination lock, an electronic combination lock, a voice activated lock, and a biometric lock.

11. The apparatus of claim 1, wherein the means for operably connecting said apparatus to a vehicle ignition system comprises electrical wires.

12. The apparatus of claim 1, wherein the means for electronically connecting said apparatus to a power source comprises electrical cables.

13. The apparatus of claim 1, wherein the means for electronically monitoring and recording certain preselected data related to the use and function of said apparatus comprises a computerized data collection system selected from the group consisting of a CPU, a flash drive, and an Internet based cloud system.

14. A system for controlling access to a handheld device by a vehicle operator while the vehicle is in operation; the system comprises: a handheld device; and an apparatus for mechanically controlling access by a vehicle operator to the handheld device while the vehicle is being operated by the vehicle operator, the apparatus comprising: a housing, said housing comprising a releasable lid, said lid hingedly connected to said housing; means for selectively locking said lid in a closed position relative to said housing; a means for operably connecting said apparatus to a vehicle ignition system; means for electronically connecting said handheld device to the interior of said housing; means for electronically connecting said apparatus to a power source; and means for electronically monitoring and recording certain preselected data related to the use and function of said apparatus.

15. The apparatus of claim 14, wherein the lid of the housing is at least partially transparent.

16. The apparatus of claim 14, herein the transparent portion of the lid comprises a material selected from the group consisting of glass, polystyrene, polycarbonate, and silicone.

17. The apparatus of claim 14, wherein the apparatus further comprises means for releasably, movably, and mechanically connecting said housing to the interior of said vehicle.

18. The apparatus of claim 14, wherein the apparatus does not comprise a means of wirelessly disrupting an electronic signal communicated to or from the handheld device.

19. The apparatus of claim 14, wherein the housing of the apparatus is generally constructed of a material selected from the group consisting of aluminum, thermoplastic, thermoset, composite, and stainless steel.

20. The apparatus of claim 14, wherein the apparatus further comprises a manual override switch operably connected between the device and the ignition and the vehicle.

21. The apparatus of claim 14, wherein the apparatus further comprises a USB connection between the apparatus and the handheld device.

22. The apparatus of claim 14, wherein the apparatus further comprises a second power source.

23. The apparatus of claim 22, wherein the second power source is selected power source is selected from the group consisting of a lead acid battery, a nickel cadmium battery, a lithium ion battery, and a solar cell.

24. The apparatus of claim 14, wherein the means for selectively closing said lid relative to said housing comprises a lock, said lock selected from the group consisting of a key lock, a combination lock, an electronic combination lock, a voice activated lock, and a biometric lock.

25. The apparatus of claim 14, wherein the means for operably connecting said apparatus to a vehicle ignition system comprises electrical wires.

26. The apparatus of claim 14, wherein the means for electronically connecting said handheld device to the interior of said housing comprises a USB connection.

27. The apparatus of claim 14, wherein the means for electronically connecting said apparatus to a power source comprises electrical cables.

28. The apparatus of claim 14, wherein the means for electronically monitoring and recording certain preselected data related to the use and function of said apparatus comprises a computerized data collection system selected from the group consisting of a CPU, a flash drive, and an Internet based cloud system.

29. A method of mechanically controlling access by a vehicle operator to a handheld device, the method comprising the steps of: providing an apparatus for mechanically controlling access by a vehicle operator to a handheld device while the vehicle is being operated by the vehicle operator, the apparatus comprising: a housing, said housing comprising a releasable lid, said lid hingedly connected to said housing; means for selectively locking said lid in a closed position relative to said housing; a means for operably connecting said apparatus to a vehicle ignition system; means for electronically connecting said handheld device to the interior of said housing; means for electronically connecting said apparatus to a power source; means for electronically monitoring and recording certain preselected data related to the use and function of said apparatus; programming said apparatus to activate upon starting the vehicle, check for predetermined desired operating conditions, record a fault if said predetermined operating conditions are not present, and deny operation of the vehicle until the conditions are met or an override is engaged.
